(19) United States
(12) Patent Application Publication
(10) Pub. No.: US 2009/0043540 A1
(43) Pub. Date: Feb. 12, 2009

(54) Performance Testing of Message Passing Operations in a Parallel Computer

(76) Inventor: Ahmad A Faraj, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/837,024

(22) Filed: Aug. 10, 2007

(51) Int. Cl. G06F 15/00

(52) U.S. Cl. 702/186

(57) ABSTRACT

Methods, apparatus, and products are disclosed for performance testing of message passing operations in a parallel computer, the parallel computer comprising a plurality of compute nodes organized into at least one operational group, that include: establishing, on a compute node of the operational group, a number of measurement iterations for testing a message passing operation, a first group of the measurement iterations designated as warm-up iterations, and a second group of the measurement iterations designated as testing iterations; for each measurement iteration: executing, by the compute node, the message passing operation under test, and measuring, by the compute node, an elapsed time for only the execution of the message passing operation under test; and determining, by the compute node, a performance result in dependence upon the elapsed time for each measurement iteration designated as one of the testing iterations.

### STATEMENT REGARDING FEDERALLY SPONSORED RESEARCH OR DEVELOPMENT

This invention was made with Government support under Contract No. B554331 awarded by the Department of Energy. The Government has certain rights in this invention.

### BACKGROUND OF THE INVENTION

1. Field of the Invention

The field of the invention is data processing, or, more specifically, methods, apparatus, and products for performance testing of message passing operations in a parallel computer.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Parallel computing is an area of computer technology that has experienced advances. Parallel computing is the simultaneous execution of the same task (split up and specially adapted) on multiple processors in order to obtain results faster. Parallel computing is based on the fact that the process of solving a problem usually can be divided into smaller tasks, which may be carried out simultaneously with some coordination.

Parallel computers execute parallel algorithms. A parallel algorithm can be split up to be executed a piece at a time on many different processing devices, and then put back together again at the end to get a data processing result. Some algorithms are easy to divide up into pieces. Splitting up the job of checking all of the numbers from one to a hundred thousand to see which are primes could be done, for example, by assigning a subset of the numbers to each available processor, and then putting the list of positive results back together. In this specification, the multiple processing devices that execute the individual pieces of a parallel program are referred to as ‘compute nodes.’ A parallel computer is composed of compute nodes and other processing nodes as well, including, for example, input/output (‘I/O’) nodes, and service nodes.

Parallel algorithms are valuable because it is faster to perform some kinds of large computing tasks via a parallel algorithm than it is via a serial (non-parallel) algorithm, because of the way modern processors work. It is far more difficult to construct a computer with a single fast processor than one with many slow processors with the same throughput. There are also certain theoretical limits to the potential speed of serial processors. On the other hand, every parallel algorithm has a serial part and so parallel algorithms have a saturation point. After that point adding more processors does not yield any more throughput but only increases the overhead and cost.

Parallel algorithms are designed also to optimize one more resource the data communications requirements among the nodes of a parallel computer. There are two ways parallel processors communicate, shared memory or message passing. Shared memory processing needs additional locking for the data and imposes the overhead of additional processor and bus cycles and also serializes some portion of the algorithm.

Message passing processing uses high-speed data communications networks and message buffers, but this communication adds transfer overhead on the data communications networks as well as additional memory needed for message buffers and latency in the data communications among nodes. Designs of parallel computers use specially designed data communications links so that the communication overhead will be small but it is the parallel algorithm that decides the volume of the traffic.

Many data communications network architectures are used for message passing among nodes in parallel computers. Compute nodes may be organized in a network as a ‘torus’ or ‘mesh,’ for example. Also, compute nodes may be organized in a network as a tree. A torus network connects the nodes in a three-dimensional mesh with wrap around links. Every node is connected to its six neighbors through this torus network, and each node is addressed by its x, y, z coordinate in the mesh. In a tree network, the nodes typically are connected into a binary tree: each node has a parent, and two children (although some nodes may only have zero children or one child, depending on the hardware configuration). In computers that use a torus and a tree network, the two networks typically are implemented independently of one another, with separate routing circuits, separate physical links, and separate message buffers.

A torus network generally supports point-to-point communications. A tree network, however, typically only supports communications where data from one compute node migrates through tiers of the tree network to a root compute node or where data is multicast from the root to all of the other compute nodes in the tree network. In such a manner, the tree network lends itself to collective operations such as, for example, reduction operations or broadcast operations. The tree network, however, does not lend itself to and is typically inefficient for point-to-point operations.

As mentioned above, the compute nodes of a parallel computer may use message passing operations to share data through such data communications networks described above. These message passing operations may include both point-to-point operations and collective operations. Although some message passing operations attempt to provide the same functionality, the implementations of such message passing operations typically vary due to the different operating environment in which each message passing operation is executed. To compare message passing operations or seek out potential optimization opportunities, system architects generally perform performance testing on the various message passing operations. In the current art, however, such performance testing often fails to precisely measure the performance of a message passing operation without introducing artificial noise in the data that represents the performance of the operation. Because of the limitations of current performance testing, such performance testing often leads to wrong conclusions concerning the performance of a particular message passing operation or hinders insights that may improve performance. As such, readers will appreciate that room for improvements exists in performance testing of message passing operations in a parallel computer.

### SUMMARY OF THE INVENTION

Methods, apparatus, and products are disclosed for performance testing of message passing operations in a parallel computer, the parallel computer comprising a plurality of compute nodes organized into at least one operational group, that include: establishing, on a compute node of the operational group, a number of measurement iterations for testing a message passing operation, a first group of the measurement iterations designated as warm-up iterations, and a second group of the measurement iterations designated as testing iterations; for each measurement iteration: executing, by the compute node, the message passing operation under test, and measuring, by the compute node, an elapsed time for only the execution of the message passing operation under test; and determining, by the compute node, a performance result in dependence upon the elapsed time for each measurement iteration designated as one of the testing iterations.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates an exemplary parallel computer for performance testing of message passing operations according to embodiments of the present invention.

FIG. 2 sets forth a block diagram of an exemplary compute node useful in a parallel computer capable of performance testing of message passing operations according to embodiments of the present invention.

FIG. 3A illustrates an exemplary Point To Point Adapter useful in a parallel computer capable of performance testing of message passing operations according to embodiments of the present invention.

FIG. 3B illustrates an exemplary Global Combining Network Adapter useful in a parallel computer capable of performance testing of message passing operations according to embodiments of the present invention.

FIG. 4 sets forth a line drawing illustrating an exemplary data communications network optimized for point to point operations useful in a parallel computer capable of performance testing of message passing operations according to embodiments of the present invention.

FIG. 5 sets forth a line drawing illustrating an exemplary data communications network optimized for collective operations useful in a parallel computer capable of performance testing of message passing operations according to embodiments of the present invention.

FIG. 6 sets forth a flow chart illustrating an exemplary method for performance testing of message passing operations in a parallel computer according to the present invention.

FIG. 7A sets forth an exemplary listing of pseudo-code that describes performance testing of message passing operations in a parallel computer according to embodiments of the present invention.

FIG. 7B sets forth a further exemplary listing of pseudo-code that describes performance testing of message passing operations in a parallel computer according to embodiments of the present invention.

FIG. 8A sets forth a line drawing illustrating an exemplary time measurement data structure useful in a parallel computer capable of performance testing of message passing operations according to embodiments of the present invention.

FIG. 8B sets forth a line drawing illustrating a further exemplary time measurement data structure useful in a parallel computer capable of performance testing of message passing operations according to embodiments of the present invention.

FIG. 8C sets forth a line drawing illustrating a further exemplary time measurement data structure useful in a parallel computer capable of performance testing of message passing operations according to embodiments of the present invention.

### DETAILED DESCRIPTION OF EXEMPLARY EMBODIMENTS

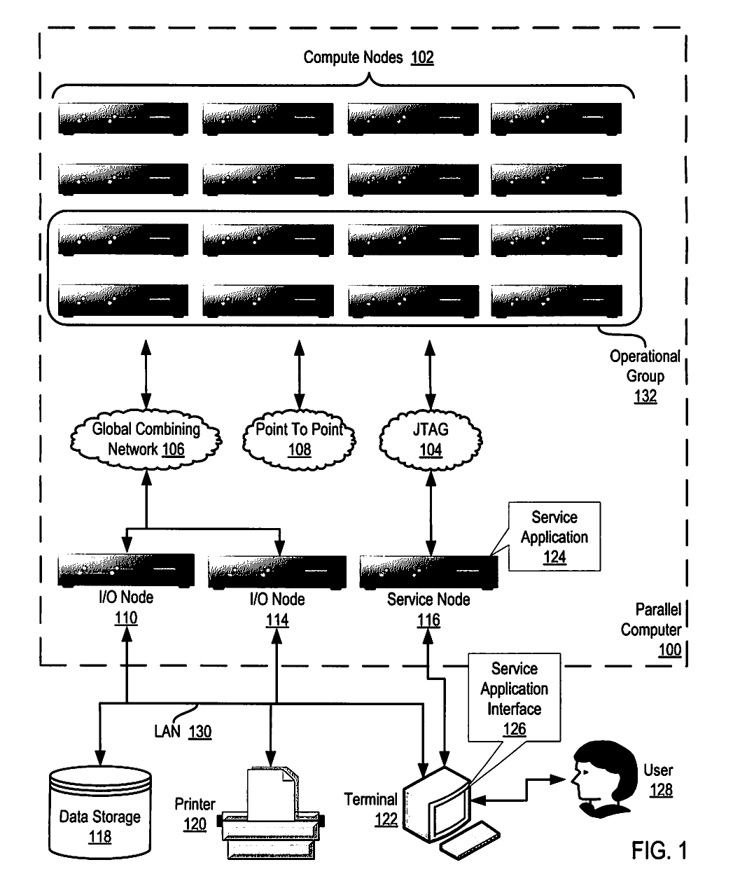

Exemplary methods, apparatus, and computer program products for performance testing of message passing operations in a parallel computer according to embodiments of the present invention are described with reference to the accompanying drawings, beginning with FIG. 1. FIG. 1 illustrates an exemplary parallel computer for performance testing of message passing operations according to embodiments of the present invention. The system of FIG. 1 includes a parallel computer (100), non-volatile memory for the computer in the form of data storage device (118), an output device for the computer in the form of printer (120), and an input/output device for the computer in the form of computer terminal (122). Parallel computer (100) in the example of FIG. 1 includes a plurality of compute nodes (102).

The compute nodes (102) are coupled for data communications by several independent data communications networks including a Joint Test Action Group (‘JTAG’) network (104), a global combining network (106) which is optimized for collective operations, and a torus network (108) which is optimized point to point operations. The global combining network (106) is a data communications network that includes data communications links connected to the compute nodes so as to organize the compute nodes as a tree. Each data communications network is implemented with data communications links among the compute nodes (102). The data communications links provide data communications for parallel operations among the compute nodes of the parallel computer. The links between compute nodes are bi-directional links that are typically implemented using two separate directional data communications paths.

In addition, the compute nodes (102) of parallel computer are organized into at least one operational group (132) of compute nodes for collective parallel operations on parallel computer (100). An operational group of compute nodes is the set of compute nodes upon which a collective parallel operation executes. Collective operations are implemented with data communications among the compute nodes of an operational group. Collective operations are those functions that involve all the compute nodes of an operational group. A collective operation is an operation, a message-passing computer program instruction that is executed simultaneously, that is, at approximately the same time, by all the compute nodes in an operational group of compute nodes. Such an operational group may include all the compute nodes in a parallel computer (100) or a subset all the compute nodes. Collective operations are often built around point to point operations. A collective operation requires that all processes on all compute nodes within an operational group call the same collective operation with matching arguments. A ‘broadcast’ is an example of a collective operation for moving data among compute nodes of an operational group. A ‘reduce’ operation is an example of a collective operation that executes arithmetic or logical functions on data distributed among the compute nodes of an operational group. An operational group may be implemented as, for example, an MPI ‘communicator.’

‘MPI’ refers to ‘Message Passing Interface,’ a prior art parallel communications library, a module of computer program instructions for data communications on parallel computers. Examples of prior-art parallel communications libraries that may be improved for use with systems according to embodiments of the present invention include MPI and the ‘Parallel Virtual Machine’ (‘PVM’) library. PVM was developed by the University of Tennessee, The Oak Ridge National Laboratory, and Emory University. MPI is promulgated by the MPI Forum, an open group with representatives from many organizations that define and maintain the MPI standard. MPI at the time of this writing is a de facto standard for communication among compute nodes running a parallel program on a distributed memory parallel computer. This specification sometimes uses MPI terminology for ease of explanation, although the use of MPI as such is not a requirement or limitation of the present invention.

Some collective operations have a single originating or receiving process running on a particular compute node in an operational group. For example, in a ‘broadcast’ collective operation, the process on the compute node that distributes the data to all the other compute nodes is an originating process. In a ‘gather’ operation, for example, the process on the compute node that received all the data from the other compute nodes is a receiving process. The compute node on which such an originating or receiving process runs is referred to as a logical root.

Most collective operations are variations or combinations of four basic operations: broadcast, gather, scatter, and reduce. The interfaces for these collective operations are defined in the MPI standards promulgated by the MPI Forum. Algorithms for executing collective operations, however, are not defined in the MPI standards. In a broadcast operation, all processes specify the same root process, whose buffer contents will be sent. Processes other than the root specify receive buffers. After the operation, all buffers contain the message from the root process.

In a scatter operation, the logical root divides data on the root into segments and distributes a different segment to each compute node in the operational group. In scatter operation, all processes typically specify the same receive count. The send arguments are only significant to the root process, whose buffer actually contains sendcount*N elements of a given data type, where N is the number of processes in the given group of compute nodes. The send buffer is divided and dispersed to all processes (including the process on the logical root). Each compute node is assigned a sequential identifier termed a ‘rank.’ After the operation, the root has sent sendcount data elements to each process in increasing rank order. Rank 0 receives the first sendcount data elements from the send buffer. Rank 1 receives the second sendcount data elements from the send buffer, and so on.

A gather operation is a many-to-one collective operation that is a complete reverse of the description of the scatter operation. That is, a gather is a many-to-one collective operation in which elements of a datatype are gathered from the ranked compute nodes into a receive buffer in a root node.

A reduce operation is also a many-to-one collective operation that includes an arithmetic or logical function performed on two data elements. All processes specify the same ‘count’ and the same arithmetic or logical function. After the reduction, all processes have sent count data elements from computer node send buffers to the root process. In a reduction operation, data elements from corresponding send buffer locations are combined pair-wise by arithmetic or logical operations to yield a single corresponding element in the root process's receive buffer. Application specific reduction operations can be defined at runtime. Parallel communications libraries may support predefined operations. MPI, for example, provides the following pre-defined reduction operations:

| | |
|---|---|
| MPI_MAX | maximum |
| MPI_MIN | minimum |
| MPI_SUM | sum |
| MPI_PROD | product |
| MPI_LAND | logical and |
| MPI_BAND | bitwise and |
| MPI_LOR | logical or |
| MPI_BOR | bitwise or |
| MPI_LXOR | logical exclusive or |
| MPI_BXOR | bitwise exclusive or |

In addition to compute nodes, the parallel computer (100) includes input/output (‘I/O’) nodes (110, 114) coupled to compute nodes (102) through the global combining network (106). The I/O nodes (110, 114) provide I/O services between compute nodes (102) and I/O devices (118, 120, 122). I/O nodes (110, 114) are connected for data communications I/O devices (118, 120, 122) through local area network (‘LAN’) (130) implemented using high-speed Ethernet. The parallel computer (100) also includes a service node (116) coupled to the compute nodes through one of the networks (104). Service node (116) provides services common to pluralities of compute nodes, administering the configuration of compute nodes, loading programs into the compute nodes, starting program execution on the compute nodes, retrieving results of program operations on the computer nodes, and so on. Service node (116) runs a service application (124) and communicates with users (128) through a service application interface (126) that runs on computer terminal (122).

As described in more detail below in this specification, the parallel computer (100) of FIG. 1 operates generally for performance testing of message passing operations according to embodiments of the present invention. The parallel computer (100) includes a plurality of compute nodes (102) organized into at least one operational group (132). The parallel computer (100) of FIG. 1 operates generally for performance testing of message passing operations according to embodiments of the present invention by: establishing, on a compute node of the operational group, a number of measurement iterations for testing a message passing operation, a first group of the measurement iterations designated as warm-up iterations, and a second group of the measurement iterations designated as testing iterations; for each measurement iteration: executing, by the compute node, the message passing operation under test, and measuring, by the compute node, an elapsed time for only the execution of the operation under test; and determining, by the compute node, a performance result in dependence upon the elapsed time for each measurement iteration designated as one of the testing iterations.

The arrangement of nodes, networks, and I/O devices making up the exemplary system illustrated in FIG. 1 are for explanation only, not for limitation of the present invention. Data processing systems capable of performance testing of message passing operations in a parallel computer according to embodiments of the present invention may include additional nodes, networks, devices, and architectures, not shown in FIG. 1, as will occur to those of skill in the art. Although the parallel computer (100) in the example of FIG. 1 includes sixteen compute nodes (102), readers will note that parallel computers capable of determining when a set of compute nodes participating in a barrier operation are ready to exit the barrier operation according to embodiments of the present invention may include any number of compute nodes. In addition to Ethernet and JTAG, networks in such data processing systems may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1.

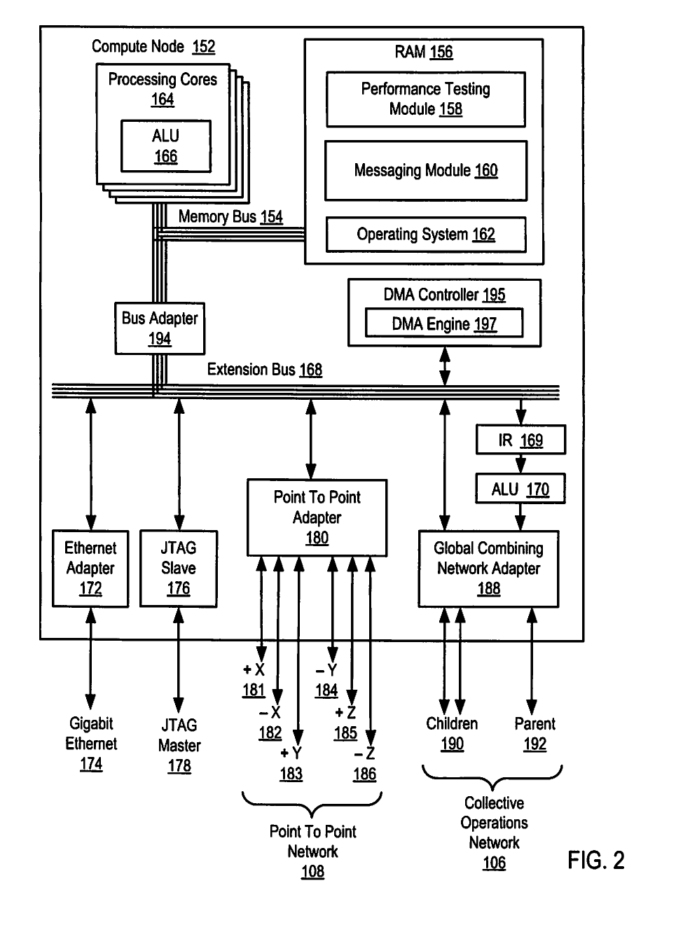

Performance testing of message passing operations according to embodiments of the present invention may be generally implemented on a parallel computer that includes a plurality of compute nodes. In fact, such computers may include thousands of such compute nodes. Each compute node is in turn itself a kind of computer composed of one or more computer processors (or processing cores), its own computer memory, and its own input/output adapters. For further explanation, therefore, FIG. 2 sets forth a block diagram of an exemplary compute node useful in a parallel computer capable of performance testing of message passing operations according to embodiments of the present invention. The compute node (152) of FIG. 2 includes one or more processing cores (164) as well as random access memory (‘RAM’) (156). The processing cores (164) are connected to RAM (156) through a high-speed memory bus (154) and through a bus adapter (194) and an extension bus (168) to other components of the compute node (152).

Stored in RAM (156) is a performance testing module (158), a module of computer program instructions that carries out parallel, user-level data processing using parallel algorithms. In particular, the performance testing module (158) of FIG. 2 operates for performance testing of message passing operations in a parallel computer according to embodiments of the present invention. The performance testing module (158) of FIG. 2 operates generally for performance testing of message passing operations in a parallel computer according to embodiments of the present invention by: establishing, on a compute node of the operational group, a number of measurement iterations for testing a message passing operation, a first group of the measurement iterations designated as warm-up iterations, and a second group of the measurement iterations designated as testing iterations; for each measurement iteration: executing, by the compute node, the message passing operation under test, and measuring, by the compute node, an elapsed time for only the execution of the operation under test; and determining, by the compute node, a performance result in dependence upon the elapsed time for each measurement iteration designated as one of the testing iterations.

Also stored in RAM (156) is a messaging module (160), a library of computer program instructions that carry out parallel communications among compute nodes, including point to point operations as well as collective operations. Application program (158) executes collective operations by calling software routines in the messaging module (160). A library of parallel communications routines may be developed from scratch for use in systems according to embodiments of the present invention, using a traditional programming language such as the C programming language, and using traditional programming methods to write parallel communications routines that send and receive data among nodes on two independent data communications networks. Alternatively, existing prior art libraries may be improved to operate according to embodiments of the present invention. Examples of prior-art parallel communications libraries include the ‘Message Passing Interface’ (‘MPI’) library and the ‘Parallel Virtual Machine’ (‘PVM’) library.

Also stored in RAM (156) is an operating system (162), a module of computer program instructions and routines for an application program's access to other resources of the compute node. It is typical for an application program and parallel communications library in a compute node of a parallel computer to run a single thread of execution with no user login and no security issues because the thread is entitled to complete access to all resources of the node. The quantity and complexity of tasks to be performed by an operating system on a compute node in a parallel computer therefore are smaller and less complex than those of an operating system on a serial computer with many threads running simultaneously. In addition, there is no video I/O on the compute node (152) of FIG. 2, another factor that decreases the demands on the operating system. The operating system may therefore be quite lightweight by comparison with operating systems of general purpose computers, a pared down version as it were, or an operating system developed specifically for operations on a particular parallel computer. Operating systems that may usefully be improved, simplified, for use in a compute node include UNIX™, Linux™, Microsoft XP™, AIX™, IBM's i5/OS™, and others as will occur to those of skill in the art.

The exemplary compute node (152) of FIG. 2 includes several communications adapters (172, 176, 180, 188) for implementing data communications with other nodes of a parallel computer. Such data communications may be carried out serially through RS-232 connections, through external buses such as Universal Serial Bus (‘USB’), through data communications networks such as IP networks, and in other ways as will occur to those of skill in the art. Communications adapters implement the hardware level of data communications through which one computer sends data communications to another computer, directly or through a network. Examples of communications adapters useful in systems for performance testing of message passing operations in a parallel computer according to embodiments of the present invention include modems for wired communications, Ethernet (IEEE 802.3) adapters for wired network communications, and 802.11b adapters for wireless network communications.

The data communications adapters in the example of FIG. 2 include a Gigabit Ethernet adapter (172) that couples example compute node (152) for data communications to a Gigabit Ethernet (174). Gigabit Ethernet is a network transmission standard, defined in the IEEE 802.3 standard, that provides a data rate of 1 billion bits per second (one gigabit). Gigabit Ethernet is a variant of Ethernet that operates over multimode fiber optic cable, single mode fiber optic cable, or unshielded twisted pair.

The data communications adapters in the example of FIG. 2 includes a JTAG Slave circuit (176) that couples example compute node (152) for data communications to a JTAG Master circuit (178). JTAG is the usual name used for the IEEE 1149.1 standard entitled Standard Test Access Port and Boundary-Scan Architecture for test access ports used for testing printed circuit boards using boundary scan. JTAG is so widely adapted that, at this time, boundary scan is more or less synonymous with JTAG. JTAG is used not only for printed circuit boards, but also for conducting boundary scans of integrated circuits, and is also useful as a mechanism for debugging embedded systems, providing a convenient “back door” into the system. The example compute node of FIG. 2 may be all three of these: It typically includes one or more integrated circuits installed on a printed circuit board and may be implemented as an embedded system having its own processor, its own memory, and its own I/O capability. JTAG boundary scans through JTAG Slave (176) may efficiently configure processor registers and memory in compute node (152) for use in performance testing of message passing operations in a parallel computer according to embodiments of the present invention.

The data communications adapters in the example of FIG. 2 includes a Point To Point Adapter (180) that couples example compute node (152) for data communications to a network (108) that is optimal for point to point message passing operations such as, for example, a network configured as a three-dimensional torus or mesh. Point To Point Adapter (180) provides data communications in six directions on three communications axes, x, y, and z, through six bidirectional links: +x (181), −x (182), +y (183), −y (184), +z (185), and −z (186).

The data communications adapters in the example of FIG. 2 includes a Global Combining Network Adapter (188) that couples example compute node (152) for data communications to a network (106) that is optimal for collective message passing operations on a global combining network configured, for example, as a binary tree. The Global Combining Network Adapter (188) provides data communications through three bidirectional links: two to children nodes (190) and one to a parent node (192).

Example compute node (152) includes two arithmetic logic units (‘ALUs’). ALU (166) is a component of each processing core (164), and a separate ALU (170) is dedicated to the exclusive use of Global Combining Network Adapter (188) for use in performing the arithmetic and logical functions of reduction operations. Computer program instructions of a reduction routine in parallel communications library (160) may latch an instruction for an arithmetic or logical function into instruction register (169). When the arithmetic or logical function of a reduction operation is a ‘sum’ or a ‘logical or,’ for example, Global Combining Network Adapter (188) may execute the arithmetic or logical operation by use of ALU (166) in processor (164) or, typically much faster, by use dedicated ALU (170).

The example compute node (152) of FIG. 2 includes a direct memory access (‘DMA’) controller (195), which is computer hardware for direct memory access and a DMA engine (197), which is computer software for direct memory access. In the example of FIG. 2, the DMA engine (197) is configured in computer memory of the DMA controller (195). Direct memory access includes reading and writing to memory of compute nodes with reduced operational burden on the central processing units (164). A DMA transfer essentially copies a block of memory from one location to another, typically from one compute node to another. While the CPU may initiate the DMA transfer, the CPU does not execute it.

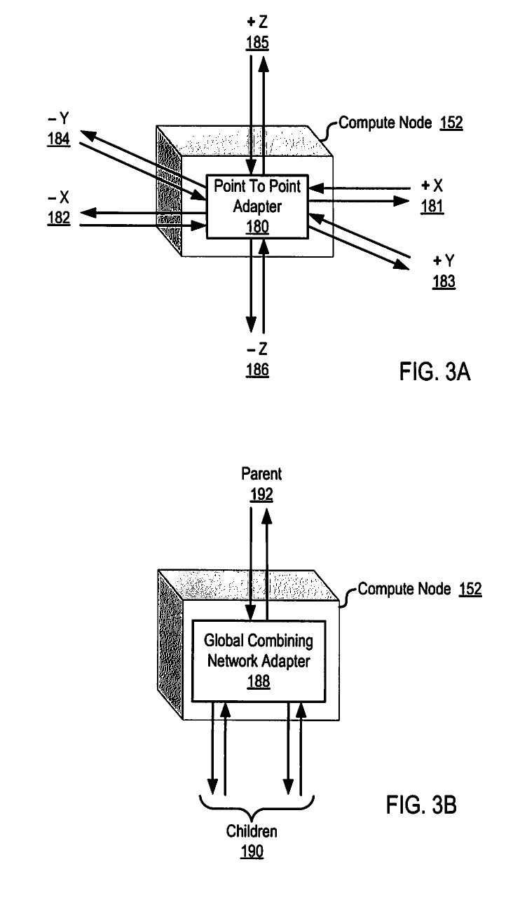

For further explanation, FIG. 3A illustrates an exemplary Point To Point Adapter (180) useful in a parallel computer capable of performance testing of message passing operations according to embodiments of the present invention. Point To Point Adapter (180) is designed for use in a data communications network optimized for point to point operations, a network that organizes compute nodes in a three-dimensional torus or mesh. Point To Point Adapter (180) in the example of FIG. 3A provides data communication along an x-axis through four unidirectional data communications links, to and from the next node in the −x direction (182) and to and from the next node in the +x direction (181). Point To Point Adapter (180) also provides data communication along a y-axis through four unidirectional data communications links, to and from the next node in the −y direction (184) and to and from the next node in the +y direction (183). Point To Point Adapter (180) in FIG. 3A also provides data communication along a z-axis through four unidirectional data communications links, to and from the next node in the −z direction (186) and to and from the next node in the +z direction (185).

For further explanation, FIG. 3B illustrates an exemplary Global Combining Network Adapter (188) useful in a parallel computer capable of performance testing of message passing operations according to embodiments of the present invention. Global Combining Network Adapter (188) is designed for use in a network optimized for collective operations, a network that organizes compute nodes of a parallel computer in a binary tree. Global Combining Network Adapter (188) in the example of FIG. 3B provides data communication to and from two children nodes (190) through two links. Each link to each child node (190) is formed from two unidirectional data communications paths. Global Combining Network Adapter (188) also provides data communication to and from a parent node (192) through a link form from two unidirectional data communications paths.

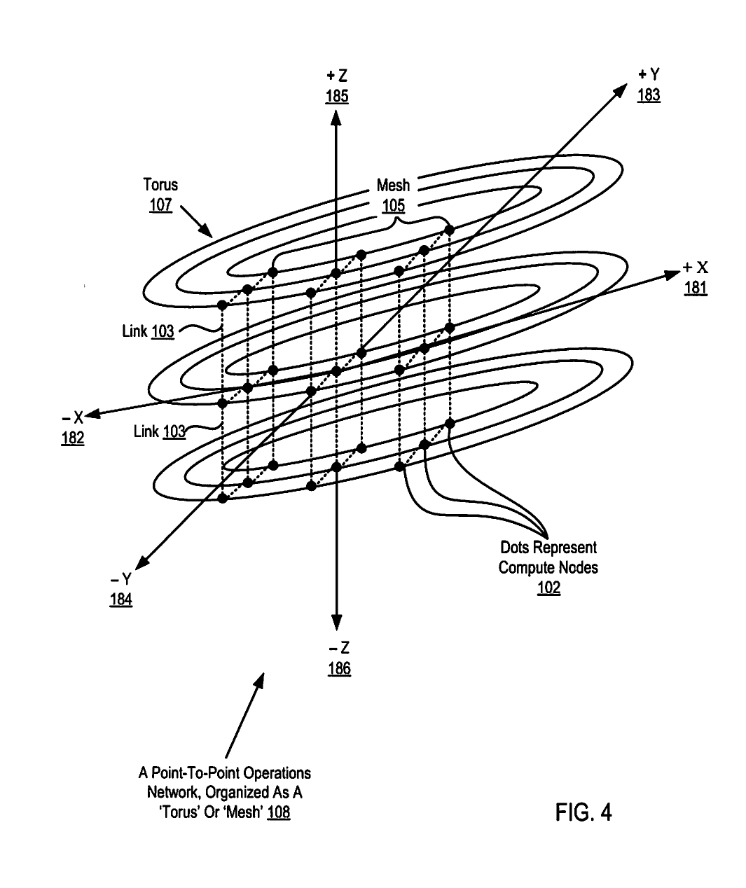

For further explanation, FIG. 4 sets forth a line drawing illustrating an exemplary data communications network (108) optimized for point to point operations useful in a parallel computer capable of performance testing of message passing operations in accordance with embodiments of the present invention. In the example of FIG. 4, dots represent compute nodes (102) of a parallel computer, and the dotted lines between the dots represent data communications links (103) between compute nodes. The data communications links are implemented with point to point data communications adapters similar to the one illustrated for example in FIG. 3A, with data communications links on three axes, x, y, and z, and to and from in six directions +x (181), −x (182), +y (183), −y (184), +z (185), and −z (186). The links and compute nodes are organized by this data communications network optimized for point to point operations into a three dimensional mesh (105). The mesh (105) has wrap-around links on each axis that connect the outermost compute nodes in the mesh (105) on opposite sides of the mesh (105). These wrap-around links form part of a torus (107). Each compute node in the torus has a location in the torus that is uniquely specified by a set of x, y, z coordinates. Readers will note that the wrap-around links in the y and z directions have been omitted for clarity, but are configured in a similar manner to the wrap-around link illustrated in the x direction. For clarity of explanation, the data communications network of FIG. 4 is illustrated with only 27 compute nodes, but readers will recognize that a data communications network optimized for point to point operations for use in performance testing of message passing operations in a parallel computer in accordance with embodiments of the present invention may contain only a few compute nodes or may contain thousands of compute nodes.

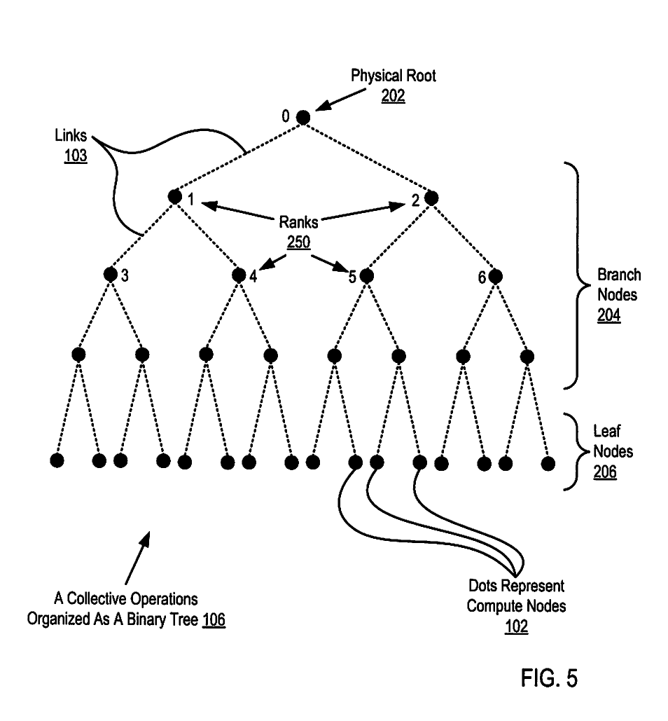

For further explanation, FIG. 5 sets forth a line drawing illustrating an exemplary data communications network (106) optimized for collective operations useful in a parallel computer capable of performance testing of message passing operations in accordance with embodiments of the present invention. The example data communications network of FIG. 5 includes data communications links connected to the compute nodes so as to organize the compute nodes as a tree. In the example of FIG. 5, dots represent compute nodes (102) of a parallel computer, and the dotted lines (103) between the dots represent data communications links between compute nodes. The data communications links are implemented with global combining network adapters similar to the one illustrated for example in FIG. 3B, with each node typically providing data communications to and from two children nodes and data communications to and from a parent node, with some exceptions. Nodes in a binary tree (106) may be characterized as a physical root node (202), branch nodes (204), and leaf nodes (206). The root node (202) has two children but no parent. The leaf nodes (206) each has a parent, but leaf nodes have no children. The branch nodes (204) each has both a parent and two children. The links and compute nodes are thereby organized by this data communications network optimized for collective operations into a binary tree (106). For clarity of explanation, the data communications network of FIG. 5 is illustrated with only 31 compute nodes, but readers will recognize that a data communications network optimized for collective operations for use in a parallel computer for performance testing of message passing operations accordance with embodiments of the present invention may contain only a few compute nodes or may contain thousands of compute nodes.

In the example of FIG. 5, each node in the tree is assigned a unit identifier referred to as a ‘rank’ (250). A node's rank uniquely identifies the node's location in the tree network for use in both point to point and collective operations in the tree network. The ranks in this example are assigned as integers beginning with 0 assigned to the root node (202), 1 assigned to the first node in the second layer of the tree, 2 assigned to the second node in the second layer of the tree, 3 assigned to the first node in the third layer of the tree, 4 assigned to the second node in the third layer of the tree, and so on. For ease of illustration, only the ranks of the first three layers of the tree are shown here, but all compute nodes in the tree network are assigned a unique rank.

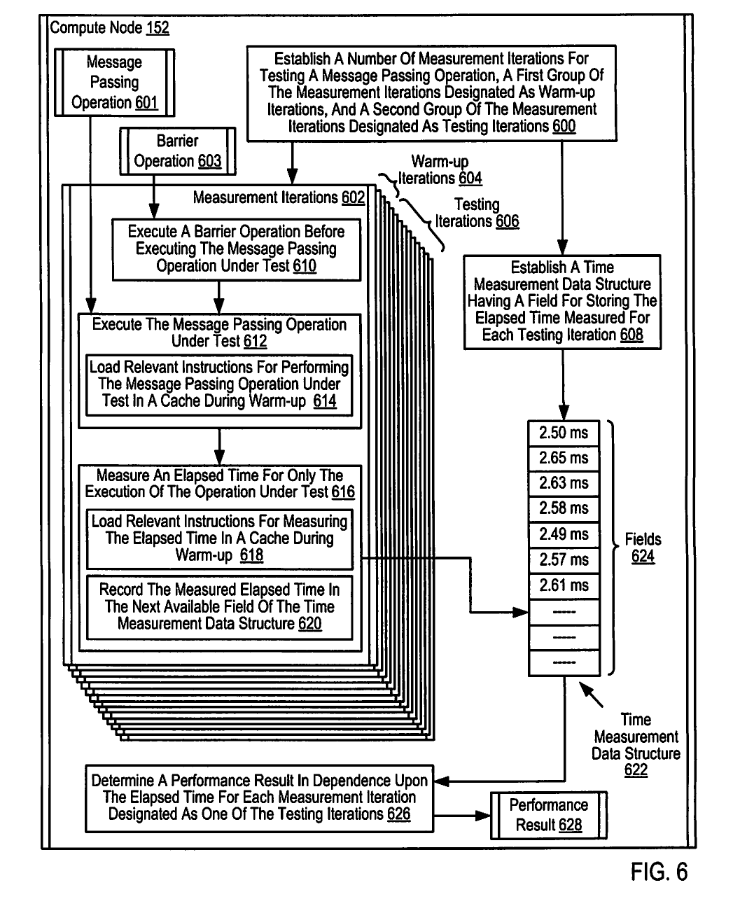

For further explanation, FIG. 6 sets forth a flow chart illustrating an exemplary method for performance testing of message passing operations in a parallel computer according to the present invention. The parallel computer includes a plurality of compute nodes organized into at least one operational group. The compute nodes share data among one another through message passing operations such as, for example, point-to-point operations or collective operations.

The method of FIG. 6 includes establishing (600), on a compute node (152) of the operational group, a number of measurement iterations (602) for testing a message passing operation (601). Each measurement iteration (602) of FIG. 6 represents a single time in which the message passing operation is performed in a programming loop. The number of measurement iterations (602) represents the total number of times in which the message passing operation is performed in the programming loop.

In the example of FIG. 6, the first group of the measurement iterations (602) are designated as warm-up iterations (604). Each warm-up iteration (604) of FIG. 6 represent a single time in which the message passing operation is executed in a programming loop and the measurements of that execution are discarded. That is, the measurements of the execution of the message passing operation are not utilized to determine the performance result for the message passing operation under test. The second group of the measurement iterations (602) of FIG. 6 are designated as testing iterations (606). Each testing iteration (606) of FIG. 6 represent a single time in which the message passing operation is executed in a programming loop and the measurements of that execution are used to determine the performance result for the message passing operation under test. Executing the message passing operation (601) in the warm-up iterations (604) before executing the message passing operation (601) in the testing iterations (606) operates to minimize the initialization effects for computing resources used to perform the message passing operation and measure the execution of the message passing operation that occur during the first measurement iterations (602). Such computer resources may include communications links in the network used to connect compute nodes, cache memory or registers where computer program instructions are stored for execution, system bus registers, network adapter registers, and so on. The initialization effects for these computing resources typically introduce noise into the data that represents the overall performance result for the message passing operation (601) under test.

The method of FIG. 6 also includes establishing (608), on the compute node (152), a time measurement data structure (622). The time measurement data structure (622) of FIG. 6 stores the elapsed times measured for each execution of the message passing operation (601) under test during the testing iterations (606). The time measurement data structure (622) of FIG. 6 has a field (624) for storing the elapsed time measured for each testing iteration (606). In the example of FIG. 6, the time measurement data structure has ten fields (624) because there are ten testing iterations (606). Readers will note, however, that such an example is for explanation only and not for limitation. Any number of testing iterations as will occur to those of skill in the art may be useful in performance testing of message passing operations in a parallel computer according to embodiments of the present invention.

For each measurement iteration (602), the method of FIG. 6 includes:
executing (610), by the compute node (152), a barrier operation (603) before executing the message passing operation (601) under test;
executing (612), by the compute node (152), the message passing operation (601) under test; and
measuring (616), by the compute node (152), an elapsed time for only the execution of the operation under test.

The barrier operation (603) of FIG. 6 represents an operation that prevents any single compute node in an operational group from processing beyond a particular point in a parallel algorithm until all of the other compute nodes reach the same point in the algorithm. In such a manner, the barrier operation (603) provides synchronization among the compute nodes in an operational group and helps to prevent race conditions. The barrier operation (603) of FIG. 6 may be implemented using, for example, the MPI_BARRIER function described in the Message Passing Interface (‘MPI’) specification that is promulgated by the MPI Forum. Executing (610), by the compute node (152), a barrier operation before executing the message passing operation under test according to the method of FIG. 6 may be carried out by executing computer program instructions for the barrier operation before executing any computer program instructions for executing the message passing operation (601) or for measuring the elapsed time for execution of the message passing operation (601). Executing the barrier operation (603) in such a manner helps reduce the effects of the barrier operation (603) on the overall performance result of the message passing operation (601).

Executing (612), by the compute node (152), the message passing operation under test in the method of FIG. 6 includes loading (620) relevant instructions for performing the message passing operation (601) under test in a cache during the warm-up iterations (604). Loading (620) relevant instructions for performing the message passing operation (601) under test in a cache during the warm-up iterations (604) according to the method of FIG. 6 allows those computer program instructions to be retrieved from the cache for execution during the testing iterations (606), rather than from slower primary memory where those instructions are stored prior to execution in the first warm-up iteration (604).

Measuring (616), by the compute node (152), an elapsed time for only the execution of the operation under test in the method of FIG. 6 includes loading (618) relevant instructions for measuring the elapsed time in a cache during the warm-up iterations (604). As mentioned above, loading (618) relevant instructions for measuring the elapsed time in a cache during the warm-up iterations (604) allows those computer program instructions to be retrieved from the cache for execution during the testing iterations (606), rather than from slower primary memory where those instructions are stored prior to execution in the first warm-up iteration (604).

Measuring (616), by the compute node (152), an elapsed time for only the execution of the message passing operation under test according to the method of FIG. 6 may be carried out by identifying the number of clock cycles that occur on a clock during the execution of the message passing operation (601) and calculating the elapsed time in dependence upon the number of clock cycles that occur. For example, if 1.25 million clock cycles occur during the execution of the message passing operation (601) and the clock operates at 500 million clock cycles per second, then the elapsed time may be calculated as follows:

$$\begin{matrix}T = C \div F \\ = 1.25 million clock cycles \div 500 million clock cycles per second \\ = .0025 seconds or 2.5 milliseconds ,\end{matrix}$$

where ‘T’ is the elapsed time, ‘C’ is the number of clock cycles that occur on a clock during the execution of the message passing operation, and ‘F’ is the frequency of the occurrence of the clock cycles on the clock.

Measuring (616), by the compute node (152), an elapsed time for only the execution of the operation under test in the method of FIG. 6 also includes recording (620) the measured elapsed time in the next available field (624) of the time measurement data structure (622), including overwriting any of the measured elapsed times for the warm-up iterations (604) with the measured elapsed time for one of the testing iterations (606). The compute node (152) may record (620) the measured elapsed time in the next available field (624) of the time measurement data structure (622) according to the method of FIG. 6 by storing the elapsed time for the first measurement iteration (602) in the first field of the time measurement data structure (622), consecutively storing the elapsed time for each subsequent measurement iteration (602) in the next adjacent field of the time measurement data structure (622) until the last field contains an elapsed time, and returning to the first field of the data structure (622), continuing to consecutively store the elapsed time for each subsequent measurement iteration (602) in the next adjacent field of the time measurement data structure (622). In such a manner, the elapsed times for the warm-up iterations (604) are overwritten in the time measurement data structure (622) with the measured elapsed time for the last testing iterations (606).

The method of FIG. 6 also includes determining (626), by the compute node, a performance result (628) in dependence upon the elapsed time for each measurement iteration (602) designated as one of the testing iterations (606). The performance result (628) of FIG. 6 represents the performance of the message passing operation (601) over one or more of the testing iterations (606). The compute node may determine (626) a performance result (628) according to the method of FIG. 6 by calculating the average of the elapsed times measured during the testing iterations (606), identifying the mode of all of the elapsed times measured during the testing iterations (606), selecting the highest or lowest elapsed time measured during the testing iterations (606), or any other implementation as will occur to those of skill in the art.

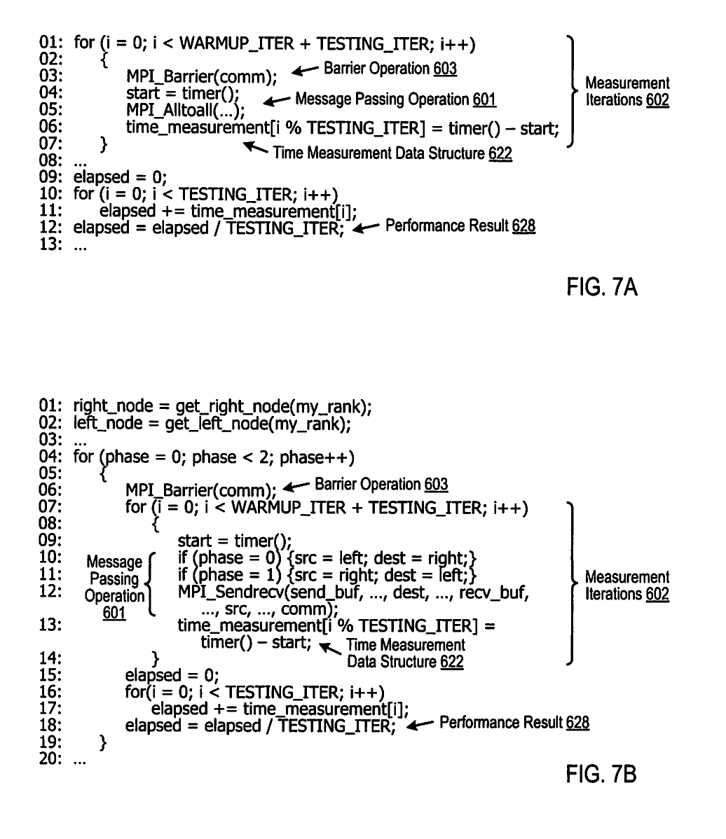

For further explanation, consider FIG. 7A that sets forth an exemplary listing of pseudo-code that describes performance testing of message passing operations in a parallel computer according to embodiments of the present invention in which the message passing operation (601) is implemented as an ‘all-to-all’ message passing operation. In an all-to-all operation, a portion of a data segment is typically distributed on each of the compute nodes of an operational group. The all-to-all operation instructs each compute node of the operational group to send its portion of a data segment to all of the other compute nodes and receive each of the other compute nodes' portions of the data segment so that all of the compute node have the entire data segment.

In the exemplary pseudo-code illustrated in FIG. 7A, a number of measurement iterations (602) are established on a compute node. Each measurement iteration (602) of FIG. 7A represents a single time in which the message passing operation is performed in a programming loop. The number of measurement iterations (602) represents the total number of times in which the message passing operation is performed in the programming loop. In the example of FIG. 7A, each measurement iteration (602) begins on line 01 and ends on line 07.

In the example of FIG. 7A, a first group of the measurement iterations (602) are designated as warm-up iterations. The value of ‘WARMUP_ITER’ listed in line 01 specifies the number of warm-up iterations that make up the first group of the measurement iterations (602). Each warm-up iteration represent a single time in which the message passing operation (601) is executed in the programming loop between lines 01-07 and the measurements of that execution are discarded. That is, the measurements of the execution of the message passing operation (601) are not utilized to determine the performance result for the message passing operation under test.

In the example of FIG. 7A, a second group of the measurement iterations (602) are designated as testing iterations. The value of ‘TESTING_ITER’ listed in line 01 specifies the number of testing iterations that make up the second group of the measurement iterations (602). Each testing iteration of FIG. 7A represent a single time in which the message passing operation is executed in a programming loop between lines 01-07 and the measurements of that execution are used to determine the performance result for the message passing operation under test. As mentioned above, executing the message passing operation (601) in the warm-up iterations before executing the message passing operation (601) in the testing iterations operates to minimize the initialization effects for computing resources used to perform the message passing operation and measure the execution of the message passing operation that occur during the first measurement iterations (602). The initialization effects for these computing resources typically introduce noise into the data that represents the overall performance result for the message passing operation (601) under test.

For each measurement iteration (602) in the example of FIG. 7A: the compute node:
executes a barrier operation (603) before executing the message passing operation (601) under test;
executes the message passing operation (601) under test, and
measures an elapsed time for only the execution of the message passing operation (601) under test.

FIG. 7A illustrates pseudo-code for executing a barrier operation (603) before executing the message passing operation (601) under test in line 03. Line 03 of FIG. 7A depicts the ‘MPI_Barrier(comm)’ instruction. The ‘MPI_Barrier(comm)’ instruction of FIG. 7A instructs the compute node to enter a barrier operation and wait for all of the other compute nodes in the operational group to enter the barrier operation before processing the next computer program instructions in the parallel algorithm.

FIG. 7A illustrates pseudo-code for executing the message passing operation (601) under test and measuring an elapsed time for only the execution of the message passing operation (601) under test in lines 04 through 05. The exemplary pseudo-code of FIG. 7A specifies executing the message passing operation (601) using the ‘MPI_Alltoall( . . . ).’ The exemplary pseudo-code of FIG. 7A specifies measuring the elapsed time for only the execution of the message passing operation (601) using the instruction ‘start =timer( )’ listed on line 04 immediately before the message passing operation (601) and using the instruction ‘time_measurement[i % TESTING_ITER]=timer( )−start’ listed on line 06 immediately after the message passing operation (601). The ‘start=timer( )’ instruction of FIG. 7A instructs a compute node to store the current value of a timer in the ‘start’ variable. The ‘time_measurement[i % TESTING_ITER]=timer( )−start’ instruction of FIG. 7A instructs a compute node to store the difference between the current value of a timer and the value of the ‘start’ variable in a field of the ‘time_measurement’ data structure (622). The difference between the current value of a timer and the value of the ‘start’ variable in the example of FIG. 7A represents the elapsed time for only the execution of the message passing operation (601) under test. The field of the ‘time_measurement’ data structure (622) in which this elapsed time is stored is identified by modulus of the value for the identifier ‘i’ of the current measurement iteration (602) with the number of testing iterations specified by ‘TESTING_ITER.’ In such a manner, the elapsed times for the warm-up iterations are overwritten in the time measurement data structure (622) with the measured elapsed time for the last testing iterations.

Readers will note that during the warm-up iterations, executing the message passing operation (601) listed in line 05 of FIG. 7A loads the relevant instructions for performing the message passing operation (601) under test in a cache. Similarly, measuring an elapsed time for only the execution of the message passing operation (601) as illustrated in lines 04 and 06 of FIG. 7A during the warm-up iterations loads relevant instructions for measuring the elapsed time in a cache. Loading these relevant instructions in the cache before the testing iterations begins reduces the initialization effects for the computing resources used to test the message passing operation according to embodiments of the present invention on the overall performance results.

FIG. 7A also illustrates pseudo-code for determining a performance result in dependence upon the elapsed time for each measurement iteration designated as one of the testing iterations in lines 09 through 12. The exemplary pseudo-code in lines 09 through 12 calculates the average elapsed time measured during the testing iterations.

For an additional example, consider FIG. 7B that sets forth a further exemplary listing of pseudo-code that describes performance testing of message passing operations in a parallel computer according to embodiments of the present invention in which the message passing operation (601) is implemented as a send-receive operation. A send-receive operation combines in one operation the sending of a message to a destination compute node and the receiving of another message from a source compute node. FIG. 7B illustrates pseudo-code for testing a send-receive operation in two phases. In the first phase, the node to the left of the compute node is designated as the source of the message received by the compute node, and the node to the right of the compute node is designated as the destination of the message sent by the compute node. In the second phase, the node to the right of the compute node is designated as the source of the message received by the compute node, and the node to the left of the compute node is designated as the destination of the message sent by the compute node.

In the exemplary pseudo-code illustrated in FIG. 7B, a number of measurement iterations (602) are established on a compute node. Each measurement iteration (602) of FIG. 7B represents a single time in which the message passing operation is performed in a programming loop. The number of measurement iterations (602) represents the total number of times in which the message passing operation is performed in the programming loop. In the example of FIG. 7B, each measurement iteration (602) begins on line 07 and ends on line 14.

In the example of FIG. 7B, a first group of the measurement iterations (602) are designated as warm-up iterations. The value of ‘WARMUP_ITER’ listed in line 07 specifies the number of warm-up iterations that make up the first group of the measurement iterations (602). Each warm-up iteration represent a single time in which the message passing operation (601) is executed in the programming loop between lines 07-14 and the measurements of that execution are discarded. That is, the measurements of the execution of the message passing operation (601) are not utilized to determine the performance result for the message passing operation under test. In the example of FIG. 7B, a second group of the measurement iterations (602) are designated as testing iterations. The value of ‘TESTING_ITER’ listed in line 07 specifies the number of testing iterations that make up the second group of the measurement iterations (602). Each testing iteration of FIG. 7B represent a single time in which the message passing operation is executed in a programming loop between lines 07-14 and the measurements of that execution are used to determine the performance result for the message passing operation under test.

For each measurement iteration (602) in the example of FIG. 7B: the compute node:
executes a barrier operation (603) before executing the message passing operation (601) under test;
executes the message passing operation (601) under test, and
measures an elapsed time for only the execution of the message passing operation (601) under test.

FIG. 7B illustrates pseudo-code for executing a barrier operation (603) before executing the message passing operation (601) under test in line 06. Line 06 of FIG. 7B depicts the ‘MPI_Barrier(comm)’ instruction. The ‘MPI_Barrier(comm)’ instruction of FIG. 7B instructs the compute node to enter a barrier operation and wait for all of the other compute nodes in the operational group to enter the barrier operation before processing the next computer program instructions in the parallel algorithm.

FIG. 7B illustrates pseudo-code for executing the message passing operation (601) under test and measuring an elapsed time for only the execution of the message passing operation (601) under test in lines 09 through 13. The exemplary pseudo- code of FIG. 7B specifies executing the message passing operation (601) using the ‘if’ statements and the ‘MPI_Sendrecv( . . . )’ instructions on lines 10 through 12. The exemplary pseudo-code of FIG. 7B specifies measuring the elapsed time for only the execution of the message passing operation (601) using the instruction ‘start=timer( )’ listed on line 09 immediately before the message passing operation (601) and using the instruction ‘time_measurement[i % TESTING_ITER]=timer( )−start’ listed on line 13 immediately after the message passing operation (601). The ‘start timer( )’ instruction of FIG. 7B instructs a compute node to store the current value of a timer in the ‘start’ variable. The ‘time_measurement[i % TESTING_ITER] timer( )−start’ instruction of FIG. 7B instructs a compute node to store the difference between the current value of a timer and the value of the ‘start’ variable in a field of the ‘time_measurement’ data structure (622). The difference between the current value of a timer and the value of the ‘start’ variable in the example of FIG. 7B represents the elapsed time for only the execution of the message passing operation (601) under test. The field of the ‘time_measurement’ data structure (622) in which this elapsed time is stored is identified by modulus of the value for the identifier ‘i’ of the current measurement iteration (602) with the number of testing iterations specified by ‘TESTING_ITER.’ In such a manner, the elapsed times for the warm-up iterations are overwritten in the time measurement data structure (622) with the measured elapsed time for the last testing iterations.

As discussed above, readers will note that during the warm-up iterations, executing the message passing operation (601) listed in lines 10 through 12 of FIG. 7B loads the relevant instructions for performing the message passing operation (601) under test in a cache. Similarly, measuring an elapsed time for only the execution of the message passing operation (601) as illustrated in lines 09 and 13 of FIG. 7B during the warm-up iterations loads relevant instructions for measuring the elapsed time in a cache. Loading these relevant instructions in the cache before the testing iterations begins reduces the initialization effects for the computing resources used to test the message passing operation according to embodiments of the present invention on the overall performance results.

FIG. 7B also illustrates pseudo-code for determining a performance result for the first phase in dependence upon the elapsed time for each measurement iteration designated as one of the testing iterations in lines 15 through 18. The exemplary pseudo-code in lines 15 through 18 calculates the average elapsed time measured during the testing iterations. After determining a performance result for the first phase, the process described above repeats for the second phase.

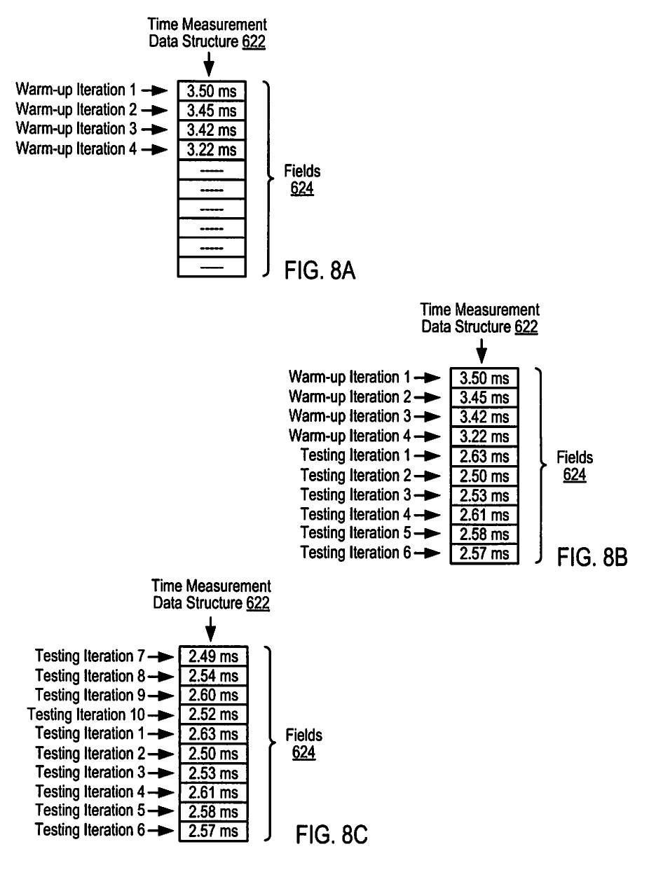

As mentioned above, a compute node may establish a time measurement data structure having a field for storing the elapsed time measured for each testing iteration. The compute node may then record the measured elapsed time in the next available field of the time measurement data structure, including overwriting any of the measured elapsed times for the warm-up iterations with the measured elapsed time for one of the testing iterations. For further explanation, FIGS. 8A-C sets forth line drawings illustrating an exemplary time measurement data structure useful in a parallel computer capable of performance testing of message passing operations according to embodiments of the present invention. The exemplary time measurement data structure (622) of FIGS. 8A-C has a field (624) for storing the elapsed time measured for each testing iteration in performance testing of message passing operations in a parallel computer according to embodiments of the present invention. For example only, consider that four measurement iterations are designated as warm-up iterations and ten measurement iterations are designated as testing iterations. In the example of FIGS. 8A-C, therefore, the time measurement data structure (622) has ten fields (624).

FIG. 8A illustrates the contents of a time measurement data structure (622) after a compute node iterates through four warm-up iterations. During the four warm-up iterations, the compute node executes the message passing operation and measures an elapsed time for the execution of the message passing operation. When measuring the elapsed time for the execution of the message passing operation, the compute node records the measured elapsed time in the next available field (624) of the time measurement data structure (622).

FIG. 8B illustrates the contents of a time measurement data structure (622) after a compute node iterates through four warm-up iterations and six of the ten testing iterations. During the four warm-up iterations and the six testing iterations, the compute node executes the message passing operation and measures an elapsed time for the execution of the message passing operation. When measuring the elapsed time for the execution of the message passing operation, the compute node records the measured elapsed time in the next available field (624) of the time measurement data structure (622).

FIG. 8B illustrates the contents of a time measurement data structure (622) after a compute node iterates through four warm-up iterations and all ten of the testing iterations. During the four warm-up iterations and the ten testing iterations, the compute node executes the message passing operation and measures an elapsed time for the execution of the message passing operation. When measuring the elapsed time for the execution of the message passing operation, the compute node records the measured elapsed time in the next available field (624) of the time measurement data structure (622) until the compute node encounters the last field in the time measurement data structure (622). Upon encountering the last field in the time measurement data structure (622), the compute node returns to the first field of the data structure (622) and starts again recording the measured elapsed time in the next available field (624) of the time measurement data structure (622). In such a manner, the elapsed times for the four warm-up iterations are overwritten in the time measurement data structure (622) with the measured elapsed time for the last four testing iterations (606).

Exemplary embodiments of the present invention are described largely in the context of a fully functional parallel computer system for performance testing of message passing operations. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for performance testing of message passing operations in a parallel computer, the parallel computer comprising a plurality of compute nodes, the plurality of compute nodes organized into at least one operational group, the method comprising:
establishing, on a compute node of the operational group, a number of measurement iterations for testing a message passing operation, a first group of the measurement iterations designated as warm-up iterations, and a second group of the measurement iterations designated as testing iterations;
for each measurement iteration:
executing, by the compute node, the message passing operation under test, and
measuring, by the compute node, an elapsed time for only the execution of the message passing operation under test; and
determining, by the compute node, a performance result in dependence upon the elapsed time for each measurement iteration designated as one of the testing iterations.

2. The method of claim 1 wherein:
the method further comprises establishing, on the compute node, a time measurement data structure having a field for storing the elapsed time measured for each testing iteration; and
measuring, by the compute node, an elapsed time for only the execution of the message passing operation under test further comprises recording the measured elapsed time in the next available field of the time measurement data structure, including overwriting any of the measured elapsed times for the warm-up iterations with the measured elapsed time for one of the testing iterations.

3. The method of claim 1 further comprising executing, by the compute node for each measurement iteration, a barrier operation before executing the message passing operation under test.

4. The method of claim 1 wherein executing, by the compute node, the message passing operation under test further comprises loading relevant instructions for performing the message passing operation under test in a cache during the warm-up iterations.

5. The method of claim 1 wherein measuring, by the compute node, an elapsed time for only the execution of the message passing operation under test further comprises loading relevant instructions for measuring the elapsed time in a cache during the warm-up iterations.

6. The method of claim 1 wherein the plurality of compute nodes are connected for data communications through a plurality of data communications networks, at least one of the data communications networks optimized for point to point data communications, and at least one of the other data communications networks optimized for collective operations.

7. A parallel computer for performance testing of message passing operations, the parallel computer comprising a plurality of compute nodes, the plurality of compute nodes organized into at least one operational group, each compute node comprising a computer processor and computer memory operatively coupled to the computer processor, the computer memory having disposed within it computer program instructions capable of:
establishing, on a compute node of the operational group, a number of measurement iterations for testing a message passing operation, a first group of the measurement iterations designated as warm-up iterations, and a second group of the measurement iterations designated as testing iterations;
for each measurement iteration:
executing, by the compute node, the message passing operation under test, and
measuring, by the compute node, an elapsed time for only the execution of the message passing operation under test; and
determining, by the compute node, a performance result in dependence upon the elapsed time for each measurement iteration designated as one of the testing iterations.

8. The parallel computer of claim 7 wherein:
the computer memory also has disposed within it computer program instructions capable of establishing, on the compute node, a time measurement data structure having a field for storing the elapsed time measured for each testing iteration; and
measuring, by the compute node, an elapsed time for only the execution of the message passing operation under test further comprises recording the measured elapsed time in the next available field of the time measurement data structure, including overwriting any of the measured elapsed times for the warm-up iterations with the measured elapsed time for one of the testing iterations.

9. The parallel computer of claim 7 wherein the computer memory also has disposed within it computer program instructions capable of executing, by the compute node for each measurement iteration, a barrier operation before executing the message passing operation under test.

10. The parallel computer of claim 7 wherein the computer memory also has disposed within it computer program instructions capable of loading relevant instructions for performing the message passing operation under test in a cache during the warm-up iterations.

11. The parallel computer of claim 7 wherein measuring, by the compute node, an elapsed time for only the execution of the message passing operation under test further comprises loading relevant instructions for measuring the elapsed time in a cache during the warm-up iterations.

12. The parallel computer of claim 7 wherein the plurality of compute nodes are connected for data communications through a plurality of data communications networks, at least one of the data communications networks optimized for point to point data communications, and at least one of the other data communications networks optimized for collective operations.

13. A computer program product for performance testing of message passing operations in a parallel computer, the parallel computer comprising a plurality of compute nodes, the plurality of compute nodes organized into at least one operational group, the computer program product disposed upon a computer readable medium, the computer program product comprising computer program instructions capable of:
establishing, on a compute node of the operational group, a number of measurement iterations for testing a message passing operation, a first group of the measurement iterations designated as warm-up iterations, and a second group of the measurement iterations designated as testing iterations;
for each measurement iteration:
executing, by the compute node, the message passing operation under test, and
measuring, by the compute node, an elapsed time for only the execution of the message passing operation under test; and
determining, by the compute node, a performance result in dependence upon the elapsed time for each measurement iteration designated as one of the testing iterations.

14. The computer program product of claim 13 wherein:
the computer program product of claim further comprises computer program instructions capable of establishing, on the compute node, a time measurement data structure having a field for storing the elapsed time measured for each testing iteration; and
measuring, by the compute node, an elapsed time for only the execution of the message passing operation under test further comprises recording the measured elapsed time in the next available field of the time measurement data structure, including overwriting any of the measured elapsed times for the warm-up iterations with the measured elapsed time for one of the testing iterations.

15. The computer program product of claim 13 further comprising computer program instructions capable of executing, by the compute node for each measurement iteration, a barrier operation before executing the message passing operation under test.

16. The computer program product of claim 13 wherein executing, by the compute node, the message passing operation under test further comprises loading relevant instructions for performing the message passing operation under test in a cache during the warm-up iterations.

17. The computer program product of claim 13 wherein measuring, by the compute node, an elapsed time for only the execution of the message passing operation under test further comprises loading relevant instructions for measuring the elapsed time in a cache during the warm-up iterations.

18. The computer program product of claim 13 wherein the plurality of compute nodes are connected for data communications through a plurality of data communications networks, at least one of the data communications networks optimized for point to point data communications, and at least one of the other data communications networks optimized for collective operations.

19. The computer program product of claim 13 wherein the computer readable medium comprises a recordable medium.

20. The computer program product of claim 13 wherein the computer readable medium comprises a transmission medium.
